(19) United States
(12) Patent Application Publication
(10) Pub. No.: US 2005/0101184 A1
(43) Pub. Date: May 12, 2005

(54) [ELECTRICAL CONNECTING INTERFACE OF MOBILE DATA STORAGE DEVICE]

(75) Inventors: Che-Chia Chang, TAIPEI (TW); Allen Lin, TAIPEI (TW)

Correspondence Address: COMAX TECHNOLOGY INC., P.O. BOX 108-00403, TAIPEI, TW

(73) Assignee: COMAX TECHNOLOGY INC., Jung-He City, Taipei, (TW)

(21) Appl. No.: 10/905,966

(22) Filed: Jan. 28, 2005

Related U.S. Application Data
(63) Continuation-in-part of application No. 10/640,749, filed on Aug. 13, 2003.

(51) Int. Cl. H01R 13/73

(52) U.S. Cl. 439/564

(57) ABSTRACT

An electrical connection interface is disclosed to include a holder frame mounted in the case of a host system, a first electrical connector mounted inside the holder frame, and having a first connecting terminal, a second connecting terminal formed integral with one side of the first connecting terminal, a signal cable connecting the first connecting terminal to the signal connector of the host system, and a power cable connecting the second connecting terminal to the power connector of the host system, and a second electrical connector installed in a mobile data storage device for connecting to the first electrical connector to electrically connect the mobile data storage device to the host system upon insertion of the mobile data storage device into the holder frame inside the case of the host system.

This application is a Continuation-In-Part of my patent application, Ser. No. 10/640,749, filed on Aug. 13, 2003.

### DESCRIPTION

### BACKGROUND OF THE INVENTION

1. Field of the Invention

The present invention relates to an electrical connecting interface of mobile storage device and more particularly to an electrical connecting interface of mobile data storage device for transmitting data and supplying power directly without any other interface requirement.

2. Description of the Related Art

Normally, a hard disk drive is fixedly mounted inside of a computer for storing data. But a mobile hard disk may be demanded for safety and convenience in a computer. The mobile hard disk drive can be withdrawn from a computer system to back up data for data storage safety and inserted into another computer for operation therein.

A conventional mobile hard disk module comprises a hard disk and a mobile rack holding the hard disk. The hard disk comprises a fixed data connector and a fixed power connector. The mobile rack comprises an adapting connector disposed thereon, a printed circuit board, a data transmission cable with two data connectors, and a power cable with power connectors. The adapting connector is fixed on the printed circuit board along with one of the data transmission cable connectors. The mobile rack comprises a corresponding adapting connector mounted on a small printed circuit board that also has a data connector and power connector mounted thereon. Therefore, a ribbon cable with two data connector is connected to the data connectors of the mobile rack and the host computer, and a power cable is connected between power connector of the mobile rack and the host computer while the conventional mobile hard disk module is connected to the host computer.

As mentioned above, the conventional mobile hard disk module between the mobile hard disk drive and the computer is complicated, resulting in a high manufacturing cost. Further, a connection error may occur easily during installation, such a connection error may cause data transmission loss or damage to the system.

### SUMMARY OF THE INVENTION

The present invention has been accomplished under the circumstances in view. It is therefore the main object of the present invention to provide an electrical connecting interface, which simplifies the connection between a mobile data storage device and a host system, and saves the cost. It is another object of the present invention to provide an electrical connecting interface, which prevents an installation error between the mobile data storage device and the host system.

To achieve these and other objects of the present invention provides an electrical connecting interface of mobile storage device to connect electrically a host system with holder frame, the electrical connecting interface having a first electrical connector mounted on said holder frame for electrical connection between said host system and said mobile storage device that having cables at one said, and one side of the walls on holder frame having a gap which is provided the cable through on it. Therefore, the mobile storage having a second electrical connector connect directly to each other with first electrical connector according to the present invention without any other interface requirement.

### BRIEF DESCRIPTION OF THE DRAWINGS

FIG. 1 is a schematic drawing showing the connected status of an electrical connection interface according to the present invention.

FIG. 2 is a perspective view of the first electrical connector of the electrical connection interface installed in a holder frame according to the present invention.

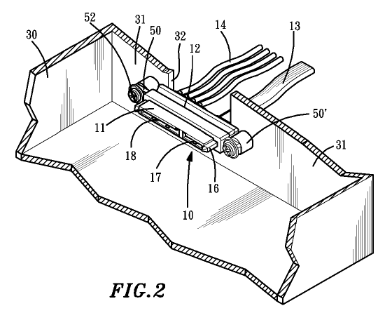

FIG. 3 is a schematic perspective view showing the second electrical connector of the electrical connection interface installed in a data storage device according to the present invention.

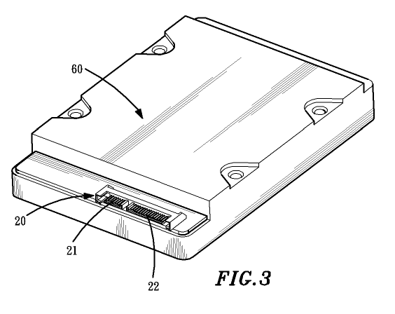

FIG. 4 is a perspective view of the first electrical connector of the electrical connection interface according to the present invention.

FIG. 5 is a sectional elevation of the first electrical connector of the electrical connection interface according to the present invention.

FIG. 6 is a schematic drawing showing an application example of the present invention.

### DETAILED DESCRIPTION OF THE EMBODIMENT

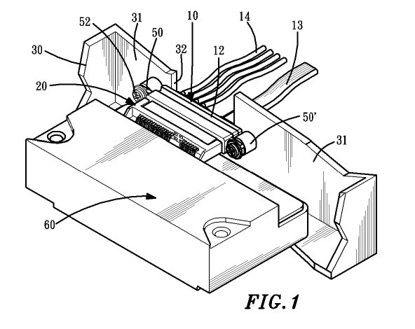

Referring to FIGS. 1˜3, the present invention provides an electrical connecting interface of mobile data storage device for electrical connecting a host system with a data storage unit. The host system is a personal computer, industrial server, or any other electric appliances. The mobile data storage device can be a mobile hard disk drive, a floppy disk drive, an optical disk drive etc. The electrical connecting interface comprises a first electrical connector 10 mounted inside a holder frame 30, and a second electrical connector 20 disposed on a data storage device 60. By means of connecting the first electrical connector 10 to the second electrical connector 20, the host system and the data storage device 60 directly electrically connect with each other to transmit data and power without any other interface requirement.

The aforesaid first electrical connector 10 and second electrical connector 20 are SATA (Serial Advanced Technology Attachment) type electrical connectors. The first electrical connector 10 comprises a first connecting terminal 17 for transmitting data, a second connecting terminal 18 for supplying power, a signal cable 13 extending from the internal circuit (not shown) of the host system and connected to the first connecting terminal 17, and a power cable 14 extending from the power circuit of the host system and connected to the second connecting terminal 18. The second electrical connector 20 comprises a first corresponding connecting terminal 21 and a second corresponding connecting terminal 22. The signal cable 13 and the power cable 14 are respectively electrically connected to the first connecting terminal 17 for transmitting data and the second connecting terminal 18 for supplying power with contact terminals 15.

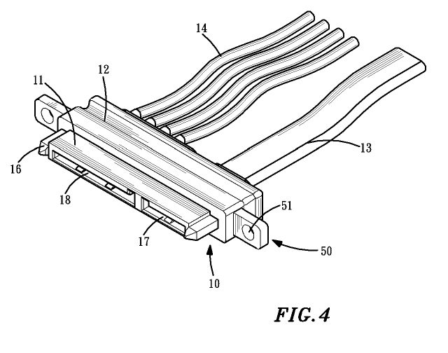

Referring to FIG. 1 and FIG. 4, the first electrical connector 10 comprises a mounting shell 50, and two guiding holes 51 symmetrically formed in the mounting shell 50 at two opposite lateral sides. The holder frame 30 comprises a mounting structure.

According to this embodiment, one side of the walls 31 on the holder frame 30 comprises a gap 32 that is provided the signal cable 13 and power cable 14 through on it, and a mounting structure at the side of the gap 32. The mounting structure of the holder frame 30 is comprised of two posts 50′ that are internally threaded posts. Alternatively, embedded nuts may be provided to substitute for the posts 50′. Fastening members, for example, screws 52 are respectively inserted through the guiding holes 51 and threaded into the posts 50′ to affix the first electrical connector 10 to the holder frame 30. The first electrical connector 10 further comprises two guiding rods 16 symmetrically forwardly extending from the front wall of the mounting shall 50 at two opposite lateral sides for guiding the first connecting terminal 17 and the second connecting terminal 18 of the first electrical connector 10 into the first corresponding connecting terminal 21 and the second corresponding connecting terminal 22 of the second electrical connector 20.

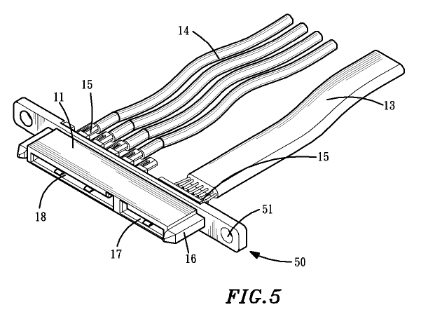

Referring to FIG. 5 and FIG. 4 again, the first electrical connector 10 further comprises a first housing 11 and a second housing 12. The contact terminals 15 insert into the first housing 11. The second housing 12 covers a part of the first housing 11, a part of the signal cable 13 and a part of the power cable 14. The first housing 11 is manufactured first. Then, the contact terminal 15 are inserted into the first housing 11. The signal cable 13 and the power cable 14 are electrically coupled with the contact terminals 15. The second housing 12 is formed in a plastic injection process to protect the contact terminals 15, the signal cable 13 and the power cable 14. The second housing 12 not only keeping the terminals 15 well protected and electrically connected between the cables 13 and 14 and the terminal 17 and 18 but also provides a perfectly firm connection.

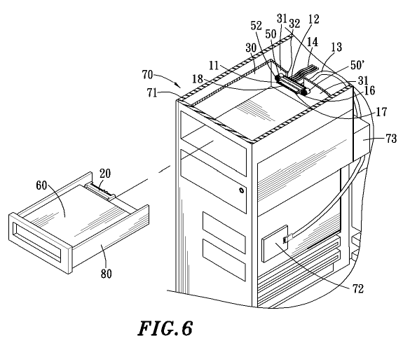

When in use, as shown in FIG. 6, the mounting shell 50 of the first electrical connector 10 is fixedly fastened to the posts 50′ of the holder frame 30, and then the holder frame 30 is fixedly fastened to the case 71 of the host system 70, keeping the signal cable 13 and the power cable 14 respectively connected to the signal connector 72 and power connector 73 of the host system 70. Further, the data storage device 60 is fixedly mounted inside a mobile rack 80. When the user inserted the mobile rack 80 into the holder frame 30, the second electrical connector 20 is forced into connection with the first electrical connector 10, and therefore the data storage device 60 is electrically connected to the host system 70.

As indicated above, the electrical connection interface of the present invention has the following features.

1. The first electrical connector 10 has a first connecting terminal 17 and a second connecting terminal 18 respectively connected to the signal connector 72 and power connector 73 of the host system 70 trough a signal cable 13 and a power cable 14 respectively for connecting the data storage device 60 to the host system 70 electrically without other interface requirement. Therefore, the connection of the data storage device 60 to the host system 70 is easy and trouble-free.

2. The first electrical connector 10 is directly electrically connected to the host system 70 through the signal cable 13 and power cable 14 thereof without through a circuit board. Because the invention eliminates the use of a circuit board, the invention saves much manufacturing cost and enhances data transmission stability.

A prototype of electrical connection interface has been constructed with the features of FIGS. 1˜6. The electrical connection interface functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

1. An electrical connecting interface of mobile storage device to connect electrically a host system with holder frame, the electrical connecting interface comprising:
a first electrical connector having cables at one side;
one side of the walls on holder frame including a gap which is provided the cable through on it, and a mounting structure forming said walls at two side of the gap that corresponding said first electrical connector;
a second electrical connector installed in a mobile data storage device for connecting to said first electrical connector;
within said mobile data storage device inserted into the first electrical connector directly without any other interface requirement.

2. The electrical connecting interface of mobile storage devices as claimed in claim 1, wherein said mobile data storage device comprises a mobile rack and a data storage device mounted inside said mobile rack; said second electrical connector is installed in said data storage device.

3. The electrical connecting interface of mobile storage device as claimed in claim 1, wherein said first electrical connector and said second electrical connector are Serial Advanced Technology Attachment type electrical connectors.

4. The electrical connecting interface of mobile storage device as claimed in claim 1, wherein the electrical connector comprises a first connecting terminal for transmitting signal and a second connecting terminal for supplying power and cables comprise a signal cable for transmitting the signals and a power cable for supplying the power.

5. The electrical connecting interface of mobile storage device as claimed in claim 1, wherein the first electrical connector comprises a first housing for inserting contact terminals and a second housing for covering a part of the first housing and a part of the cables.

6. The electrical connecting interface of mobile storage device as claimed in claim 1, wherein the second housing is formed in a plastic injection process.

7. The electrical connecting interface of mobile storage device as claimed in claim 1, wherein said first electrical connector further comprises a mounting shell fastened to the mounting structure of said holder frame.

8. The electrical connecting interface of mobile storage device as claimed in claim 7, wherein said holder frame further comprises fastening means to affix said mounting shell to said mounting structure of said holder frame.

9. The electrical connecting interface of mobile storage device as claimed in claim 7, wherein said mounting shell comprises at least one mounting hole respectively fastened to said mounting structure of said holder frame by said fastening means.

10. The electrical connecting interface of mobile storage device as claimed in claim 7, wherein said mounting structure of said mounting structure of the holder frame comprises a plurality of posts.

11. The electrical connecting interface of mobile storage device as claimed in claim 7, wherein said mounting structure of said holder frame comprises a plurality of internally threaded posts.

12. The electrical connecting interface of mobile storage device as claimed in claim 7, wherein said mounting structure of said holder frame comprises a plurality of embedded nuts.

13. The electrical connecting interface of mobile storage device as claimed in claim 7, wherein said fastening means comprises a plurality of screws for fastening said mounting shell to the mounting structure of said holder frame.

14. The electrical connecting interface of mobile storage device as claimed in claim 1, wherein said first electrical connector comprises at least one forwardly extending guiding rod for guiding said second electrical connector into electric connection with the signal connector and power connector of said first electrical connector.

15. The electrical connecting interface of mobile storage device as claimed in claim 1, wherein said data storage device is a hard disk drive.

16. The electrical connecting interface of mobile storage device as claimed in claim 1, wherein said data storage device is a floppy disk drive.

17. The electrical connecting interface of mobile storage device as claimed in claim 1, wherein said data storage device is an optical disk drive.

18. The electrical connecting interface of mobile storage device as claimed in claim 1, wherein said host system is a personal computer.

19. The electrical connecting interface of mobile storage device as claimed in claim 1, wherein said host system is an industrial server.
